(19) United States
(12) Patent Application Publication
(10) Pub. No.: US 2026/0245033 A1
(43) Pub. Date: Aug. 20, 2026

(54) ITEM SELECTION METHOD AND RELATED PRODUCTS THEREOF

(71) Applicants: Nanjing Xiyin Ecommerce Co., Ltd., Jiangsu (CN); Guangzhou Xiyin International Import and Export Co., Ltd., Guangdong (CN); Shenzhen Xiyin Information Technology Co., Ltd., Guangdong (CN)

(72) Inventors: JIE ZHANG, Jiangsu (CN); MINGYING ZHANG, Jiangsu (CN); XIANGLIN LI, Jiangsu (CN); WEIZHAO GUO, Jiangsu (CN); XINGGUO MA, Jiangsu (CN)

(21) Appl. No.: 19/259,384

(22) Filed: Jul. 3, 2025

(30) Foreign Application Priority Data
Feb. 18, 2025 (CN) 202510179762.0

(51) Int. Cl. G06Q 10/087; G06V 30/19

(52) U.S. Cl. CPC G06Q 10/087; G06V 30/19167; G06V 30/19173

(57) ABSTRACT

An item selection method includes acquiring a classification label text input by a user, determining text embedding information based on the classification label text, inputting each item image in an item library into a multi-modal image-text model to obtain image embedding information corresponding to each item image output from the multi-modal image-text model, where the multi-modal image-text model is trained based on an item picture sample set and an item information text corresponding to each item picture sample in the item picture sample set, and determining a target item based on the text embedding information and the image embedding information corresponding to each item image. Target items in accord with a new classification label can be efficiently and accurately selected from massive items, thereby satisfying the label use requirements of various business scenarios while reducing the labor cost and improving the item management efficiency.

### CROSS REFERENCE TO RELATED APPLICATIONS AND CLAIM OF PRIORITY

This application claims the benefit under 35 USC § 119 of Chinese Patent Application No. 202510179762.0 filed on Feb. 18, 2025, in the Chinese Intellectual Property Office, the entire disclosure of which is incorporated herein by reference for all purposes.

### BACKGROUND

### 1. Technical Field

The present application generally relates to the technical field of artificial intelligence. More specifically, the present application relates to an item selection method and related products thereof.

### 2. Background of the Invention

Under the context of e-commerce, various items may belong to different categories depending on the themes or festivals. At present, most of the new items are provided with classification labels and classification levels determined by a merchant when listed. However, such classification labels of items provided by the merchant cannot satisfy the use requirements in all business scenarios. For example, during Christmas, service operators may only want items with Christmas features, which are typically not classified or defined finely at the merchant end in classification labels of such items. To add a classification label to these items, a large amount of pure manual labor is required to circle and select suitable items and add the label, which is both time and labor consuming. In contrast, if items are circled and selected, and added with a label, automatically based a corresponding rule, the diversity of items will be limited, while background maintenance of the rule is complicated and redundant.

In view of this, there is an urgent need to provide an item selection method which can efficiently and accurately select a target item in accord with a new classification label from massive items, thereby satisfying the label use requirements of various business scenarios while reducing the labor cost and improving the item management efficiency.

### SUMMARY

To address at least one or more of the above technical problems, the present application proposes, in various aspects, an item selection method and related products thereof. The item selection method can efficiently and accurately select a target item in accord with a new classification label from massive items, thereby satisfying the label use requirements of various business scenarios while reducing the labor cost and improving the item management efficiency.

In a first aspect, the present application provides an item selection method, including: acquiring a classification label text input by a user; determining text embedding information based on the classification label text; inputting each item image in an item library into a multi-modal image-text model to obtain image embedding information corresponding to each item image output from the multi-modal image-text model, where the multi-modal image-text model is trained based on an item picture sample set and an item information text corresponding to each item picture sample in the item picture sample set; and determining a target item based on the text embedding information and the image embedding information corresponding to each item image.

In some embodiments, the multi-modal image-text model is trained based on the item picture sample set and the item information text corresponding to each item picture sample in the item picture sample set by: acquiring the item picture sample set and the item information text corresponding to each item picture sample in the item picture sample set; pre-processing each item picture sample and each item information text to obtain an item picture training set and an item information training set; loading a pre-training model and adding a dimension reduction layer into the pre-training model to obtain an initial image-text model; and inputting the item picture training set and the item information training set into the initial image-text model for training to obtain the multi-modal image-text model.

In some embodiments, inputting the item picture training set and the item information training set into the initial image-text model for training includes: matching each piece of training item information in the item information training set with training item pictures in the item picture training set, to obtain a plurality of positive pairing combinations and a plurality of negative pairing combinations; determining a contrastive loss value based on the plurality of positive pairing combinations and a contrastive learning loss function of the initial image-text model; determining a matching loss value based on the plurality of positive pairing combinations, the plurality of negative pairing combinations, and a matching loss function of the initial image-text model; determining a semantic description loss value based on the item information training set and a semantic loss function of the initial image-text model; determining a target loss value based on the contrastive loss value, the matching loss value, and the semantic description loss value; and determining whether the training of the initial image-text model is completed based on the target loss value.

In some embodiments, determining the contrastive loss value based on the plurality of positive pairing combinations and the contrastive learning loss function of the initial image-text model includes: inputting a training item picture in each positive pairing combination into a visual encoder of the initial image-text model to obtain an item picture feature output from the visual encoder; inputting training item information in each positive pairing combination into a text encoder of the initial image-text model to obtain an item information feature output from the text encoder; inputting the item picture feature and the item information feature into the dimension reduction layer to obtain a dimension reduction picture feature and a dimension reduction information feature; determining a similarity matrix based on the dimension reduction picture feature and the dimension reduction information feature; determining a first direction contrastive loss value and a second direction contrastive loss value based on the similarity matrix; and determining the contrastive loss value based on the first direction contrastive loss value and the second direction contrastive loss value.

In some embodiments, determining the matching loss value based on the plurality of positive pairing combinations, the plurality of negative pairing combinations, and the matching loss function of the initial image-text model includes: determining an intermediate interactive feature corresponding to each pairing combination based on the plurality of positive pairing combinations and the plurality of negative pairing combinations; determining a matching probability corresponding to each pairing combination according to the intermediate interactive feature corresponding to each pairing combination; and determining the matching loss value based on a preset classification label parameter and the matching probability corresponding to each pairing combination.

In some embodiments, determining the target item based on the text embedding information and the image embedding information corresponding to each item image includes: determining a cosine similarity of the text embedding information and the image embedding information corresponding to each item image; determining at least one candidate matching item according to the cosine similarity; and sorting the at least one candidate matching item according to a preset reference factor, and determining the target item according to a sorted result.

In some embodiments, before acquiring the classification label text input by the user, the method further includes: acquiring a new item list, where the new item list includes a new description text corresponding to each new item, and new picture information corresponding to each new item; inputting the new description text corresponding to each new item and the new picture information corresponding to each new item into the multi-modal image-text model, to obtain new text embedding information corresponding to each new item and new image embedding information corresponding to each new item output from the multi-modal image-text model; and pushing the new text embedding information corresponding to each new item and the new image embedding information corresponding to each new item to an item library index engine to update an item library index.

In some embodiments, before acquiring the classification label text input by the user, the method further includes: monitoring a data stream of item state change; determining a delisted item according to the data stream of item state change; and clearing delisting text embedding information and delisting image embedding information corresponding to the delisted item from the item library index.

In a second aspect, the present application provides a device for item selection, including: a memory; and at least one processor configured to: acquire a classification label text input by a user; determine text embedding information based on the classification label text; input each item image in an item library into a multi-modal image-text model to obtain image embedding information corresponding to each item in image output from the multi-modal image-text model, where the multi-modal image-text model is trained based on an item picture sample set and an item information text corresponding to each item picture sample in the item picture sample set; and determine a target item based on the text embedding information and the image embedding information corresponding to each item image.

In a third aspect, the present application provides a non-transitory machine-readable medium having a program code for item selection stored thereon which, when executed by at least one processor, directs the at least one processor to perform the operations of: acquiring a classification label text input by a user; determining text embedding information based on the classification label text; inputting each item image in an item library into a multi-modal image-text model to obtain image embedding information corresponding to each item image output from the multi-modal image-text model, where the multi-modal image-text model is trained based on an item picture sample set and an item information text corresponding to each item picture sample in the item picture sample set; and determining a target item based on the text embedding information and the image embedding information corresponding to each item image.

The technical solutions provided in the present application may achieve the following beneficial effects:

According to the item selection method and related products thereof provided in the present application, by acquiring a classification label text input by a user, and further determining text embedding information based on the classification label text, core semantic information of the new classification label text can be extracted. On the other hand, by inputting each item image in an item library into a multi-modal image-text model, image embedding information corresponding to each item image output from the multi-modal image-text model can be obtained. The multi-modal image-text model is trained based on the item picture sample set and the item information text corresponding to each item picture sample in the item picture sample set, so that the multi-modal image-text model has the capability of accurately extracting the item information feature of each item in the item library.

Furthermore, the present application can determine a target item based on the text embedding information and the image embedding information corresponding to each item image, so that through the efficient matching of the text embedding information and the image embedding information corresponding to each item image, the selection efficiency of the target item in accord with the classification label text is effectively improved, and item selection can be quickly and accurately completed without manual intervention.

In general, the present application can efficiently and accurately select a target item in accord with a new classification label from massive items, thereby satisfying the label use requirements of various business scenarios while reducing the labor cost and improving the item management efficiency.

### BRIEF DESCRIPTION OF THE DRAWINGS

The above and other objectives, features and advantages of exemplary implementations of the present application will become readily apparent from the following detailed description, which proceeds with reference to the accompanying drawings. In the accompanying drawings, several implementations of the present application are illustrated by way of example but not limitation, and like or corresponding reference numerals indicate like or corresponding parts, in which:

FIG. 1 shows an exemplary flowchart of an item selection method according to some embodiments of the present application;

FIG. 2 shows an exemplary flowchart of an item selection method according to some other embodiments of the present application;

FIG. 3 shows an exemplary flowchart of an item selection method according to yet other embodiments of the present application; and

FIG. 4 shows a block diagram of a hardware configuration of a device 400 for item selection for implementing the item selection method according to an embodiment of the present application.

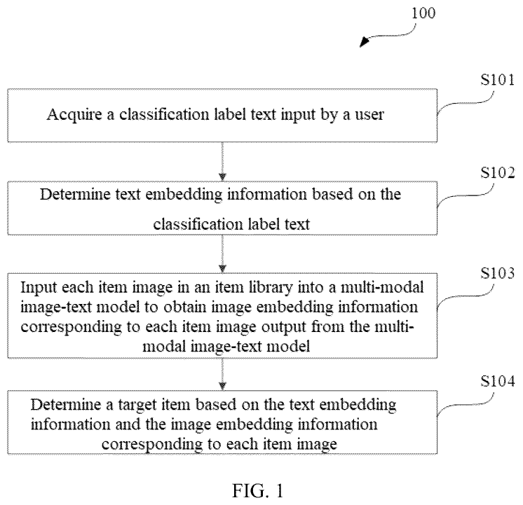

### DETAIL DESCRIPTION OF THE INVENTION

The technical solutions in the embodiments of the present application will be clearly and completely described below with reference to the accompanying drawings in the embodiments of the present application. Apparently, the described embodiments are only part, but not all, of the embodiments of the present application. For simplicity and clarity of illustration, where considered appropriate, reference numerals may be repeated among the figures to indicate corresponding or analogous elements. In addition, the present application sets forth numerous specific details to provide a thorough understanding of the embodiments described herein. However, it will be understood by one of ordinary skill in the art that the embodiments described herein may be practiced without these specific details. In other instances, well-known methods, procedures, and components have not been described in detail so as not to obscure the embodiments described herein. Moreover, the description should not be taken as limiting the scope of the embodiments described herein. All other embodiments obtained by those skilled in the art based on the embodiments in the present application without any creative labor belong to the protection scope of the present application.

It should be understood that the possible terms “first” or “second” or the like in the claims, description and drawings disclosed in the present application are used to distinguish different objects, and are not used to describe a particular order. The terms “comprise” and “include”, when used in the description and claims of the present application, specify the presence of the stated features, integers, steps, operations, elements, and/or components, but do not preclude the presence or addition of one or more other features, integers, steps, operations, elements, components, and/or groups thereof.

It is also to be understood that the terminology used in the description of the present application herein is for the purpose of describing particular embodiments only, and is not intended to limit the present application. As used in the specification and claims of the present application, the singular forms “a”, “an” and “the” are intended to include the plural forms as well, unless the context clearly indicates otherwise. It should be further understood that the term “and/or” as used in the description and claims of the present application refers to any and all possible combinations of one or more of the associated listed items and includes such combinations.

As used in this specification and claims, the term “if” may be interpreted as “when” or “once” or “in response to determining” or “in response to detecting” depending on the context. Similarly, the phrase “if it is determined” or “if [the described condition or event] is detected” may be interpreted contextually as meaning “upon determining” or “in response to determining” or “upon detecting [the described condition or event]” or “in response to detecting [the described condition or event]”.

Under the context of e-commerce, various items may belong to different categories depending on the themes or festivals. At present, most of the new items are provided with classification labels and classification levels determined by a merchant when listed. However, such classification labels of items provided by the merchant cannot satisfy the use requirements in all business scenarios. To add a classification label to these items, a large amount of pure manual labor is required to circle and select suitable items and add the label, which is both time and labor consuming. In contrast, if items are circled and selected, and added with a label, automatically based a corresponding rule, the diversity of items will be limited, while background maintenance of the rule is complicated and redundant.

In view of this, there is an urgent need to provide an item selection method which can efficiently and accurately select a target item in accord with a new classification label from massive items, thereby satisfying the label use requirements of various business scenarios while reducing the labor cost and improving the item management efficiency.

Specific implementations of the present application will be described in detail below with reference to the accompanying drawings.

At step S101, a classification label text input by a user is acquired. In the embodiments of the present application, the classification label text may refer to a description text of a new classification label, e.g., “a sleeveless print dress suitable for summer”, or refer to a label text of a new classification label, e.g., “sleeveless print dress”. It will be appreciated that the classification label text may be in various forms, and in practical applications, the form of the classification label text is determined according to practical application conditions, which is not limited in any manner in the present application.

At step S102, text embedding information is determined based on the classification label text. In an embodiment of the present application, the classification label text may be input into a natural language processing model for parsing, to extract core semantic information (such as item type, material, pattern, and the like) and obtain text embedding information. In natural language processing (NLP), text embedding is a process of converting text data into vectors of fixed dimensions, where the vectors can capture semantic information of the text so that texts of the same semantic but different expressions are mapped to similar locations in a vector space, while texts of different semantics maintain a certain distance from each other.

At step S103, each item image in an item library is input into a multi-modal image-text model to obtain image embedding information corresponding to each item image output from the multi-modal image-text model. In an embodiment of the present application, the multi-modal image-text model may be trained based on an item picture sample set and an item information text corresponding to each item picture sample in the item picture sample set, so that the multi-modal image-text model has the capability of accurately extracting the item information feature of each item in the item library. The item information text corresponding to each item picture sample may include, but is not limited to: item title, item type information, material, filling, filling weight, top type, bottom type, lower hem shape, sleeve length, sleeve type, pattern, collar type, details, thinness and transparency, function type, fleece-lined or not, style type, length, bootleg height and type, color, item main picture information, and the like. Additionally, image embedding a method of converting image data into continuous, low-dimensional vectors, where the vectors are typically used for subsequent machine learning tasks such as classification, clustering, retrieval, and the like. The purpose of image embedding is to convert high-dimensional image data into low-dimensional data that is easier to process, while retaining as much of the original image information as possible.

At step S104, a target item is determined based on the text embedding information and the image embedding information corresponding to each item image. In an embodiment of the present application, the text embedding information may be compared with the image embedding information corresponding to each item image, so that the target item can be determined according to the similarity shown by the comparison result, and item selection can be quickly and accurately completed without manual intervention.

In the embodiments of the present application, by acquiring a classification label text input by a user, and further determining text embedding information based on the classification label text, core semantic information of the new classification label text can be extracted. On the other hand, by inputting each item image in an item library into a multi-modal image-text model, image embedding information corresponding to each item image output from the multi-modal image-text model can be obtained. The multi-modal image-text model is trained based on the item picture sample set and the item information text corresponding to each item picture sample in the item picture sample set, so that the multi-modal image-text model has the capability of accurately extracting the item information feature of each item in the item library. Furthermore, the present application can determine a target item based on the text embedding information and the image embedding information corresponding to each item image, so that through the efficient matching of the text embedding information and the image embedding information corresponding to each item image, the selection efficiency of the target item in accord with the classification label text is effectively improved, and item selection can be quickly and accurately completed without manual intervention. In general, the present application can efficiently and accurately select a target item in accord with a new classification label from massive items, thereby satisfying the label use requirements of various business scenarios while reducing the labor cost and improving the item management efficiency.

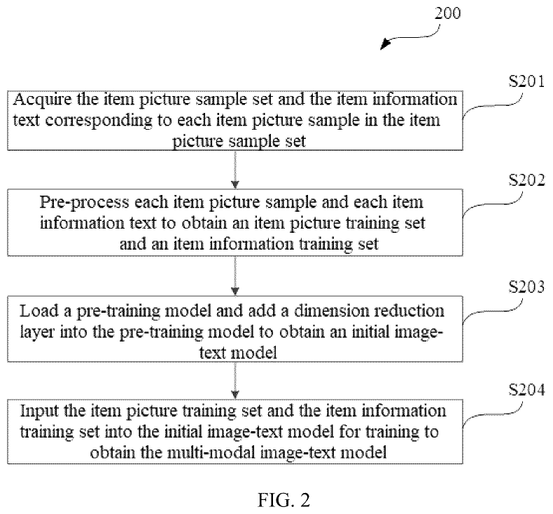

In some embodiments, the training steps of the multi-modal image-text model may be further designed. The training steps of the multi-modal image-text model will be described in detail below with reference to FIG. 2. FIG. 2 shows an exemplary flowchart of an item selection method according to some other embodiments of the present application. Referring to FIG. 2, an item selection method according to an embodiment of the present application may include the following steps S201 to S204.

At step S201, the item picture sample set and the item information text corresponding to each item picture sample in the item picture sample set are acquired. In an embodiment of the present application, images of a plurality of item scenes, such as item style images and model diagrams, may be collected to form an item picture sample set, where information such as an item title, an item category, an attribute label (material, version, color, style, detail description or the like) and the like contained in each item picture sample in the item picture sample set may be used as the item information text corresponding to each item picture sample in the item picture sample set.

At step S202, each item picture sample and each item information text are pre-processed to obtain an item picture training set and an item information training set. In an embodiment of the present application, the pre-processing may include duplication filtering, text cleaning and encoding, and image pre-processing. The duplication filtering may specifically include removing duplicate data and abnormal data (such as an invalid picture, a null text, and the like), and cleaning, if any, a noisy text or an error label. In addition, the text cleaning and encoding may specifically include merging an item title, attribute information, and the like into one or more text segments, removing unnecessary special characters, and then using a tokenizer/subword tokenizer (such as byte pair encoding (BPE)) compatible with a contrastive language-image pre-training (CLIP) model to ensure that the input is consistent with the tokenization mode during model pre-training. Furthermore, the image pre-processing may specifically include firstly cropping or scaling each item picture sample into a default input resolution of the model (e.g., 224×224), and then implementing image data augmentation by random horizontal flip, random cropping, color jittering, and the like, where the magnitude of augmentation may be adjusted according to the practical application conditions. When the pre-processing is completed, an item picture training set and an item information training set can be obtained.

At step S203, a pre-training model is loaded and a dimension reduction layer is added to the pre-training model to obtain an initial image-text model. In an embodiment of the present application, the pre-training model may be a contrastive language-image pre-training (CLIP) model, which is a multi-modal pre-training model intended to be trained with a large number of “text-image” pairs to learn and match image contents with corresponding natural language descriptions. The CLIP model embeds texts and images into a common semantic space so that representations of related text descriptions and image contents are close to each other in this space, while those non-related representations are away from each other. The pre-training model includes a visual encoder and a text encoder, and typically adopts the open-source ViT-B/32, VIT-B/16 and the like.

On the other hand, in an embodiment of the present application, to meet the requirement of finally outputting 128-dimensional embedding, a linear mapping layer (i.e., a dimension reduction layer) may be created on the original output (e.g., 512 dimensions) of the pre-training model, which may be represented by:

$$z = L i n e a {r}_{512 \to 128} ( x ) \qquad ( 1 )$$

where x is the original output of the pre-training model, and z is the output of the new linear mapping layer. In some special application scenes, to implement more flexible stepped dimension reduction, it is possible to firstly reduce the dimensions to 256 dimensions and then to 128 dimensions in a Matryoshka embedding model or the like, or directly to 128 dimensions in one go.

At step S204, the item picture training set and the item information training set are input into the initial image-text model for training to obtain the multi-modal image-text model. In an embodiment of the present application, each piece of training item information in the item information training set may be firstly matched with training item pictures in the item picture training set, to obtain a plurality of positive pairing combinations and a plurality of negative pairing combinations. A positive pairing combination refers to real pairing of a certain training item picture with training item information corresponding to the training item picture, while a negative pairing combination refers to pairing of a certain training item picture with any training item information other than the training item information corresponding to the training item picture.

Then, a contrastive loss value may be determined based on the plurality of positive pairing combinations and a contrastive learning loss function of the initial image-text model. Specifically, a training item picture in each positive pairing combination may be input into a visual encoder of the initial image-text model to obtain an item picture feature output from the visual encoder, and training item information in each positive pairing combination in input into a text encoder of the initial image-text model to obtain an item information feature output from the text encoder. Further, the item picture feature and the item information feature are input into the dimension reduction layer to obtain a dimension reduction picture feature and a dimension reduction information feature, and a similarity matrix is further determined based on the dimension reduction picture feature and the dimension reduction information feature. The similarity matrix may be calculated by:

$${s}_{i j} = \frac{{z}_{i}^{v} \cdot {z}_{j}^{t}}{‖ {z}_{i}^{v} ‖ ‖ {z}_{j}^{t} ‖} \qquad ( 2 )$$

where sᵢⱼ is the similarity matrix,

$${z}_{i}^{v}$$

is a dimension reduction picture feature obtained by dimension reduction of an i^{th} item picture feature, and

$${z}_{j}^{t}$$

is a dimension reduction information feature obtained by dimension reduction of a j^{th} item information feature, where the denominator is a product of vector norms (i.e., the cosine similarity).

Further, a first direction contrastive loss value and a second direction contrastive loss value may be determined based on the similarity matrix, where the first direction contrastive loss value may be an image-to-text contrastive loss value, which may be calculated by:

$${ℒ}_{i m a ge - to - text} ( i ) = - log ( \frac{exp ( \frac{{s}_{i i}}{τ} )}{{\sum }_{j = 1}^{N} exp ( \frac{{s}_{i j}}{τ} )} ) \qquad ( 3 )$$

where τ is a temperature coefficient (temperature) that encourages a similarity of the item picture feature Vᵢ with the matching item information feature tᵢ higher than the similarity with any mismatching item information feature tⱼ.

In addition, the second direction contrastive loss value may be a text-to-image contrastive loss value, which may be calculated by:

$${ℒ}_{text - to - image} ( i ) = - log ( \frac{exp ( \frac{{s}_{i i}}{τ} )}{{\sum }_{j = 1}^{N} exp ( \frac{{s}_{j i}}{τ} )} ) \qquad ( 4 )$$

Further, the contrastive loss value may be determined based on the first direction contrastive loss value and the second direction contrastive loss value. The contrastive loss value may be calculated by:

$${ℒ}_{contrastive} = \frac{1}{2 N} {\sum }_{i = 1}^{N} ( {ℒ}_{i m age - to - text} ( i ) + {ℒ}_{text - to - image} ( i ) ) \qquad ( 5 )$$

where N is a total number of positive pairing combinations.

Next, a matching loss value may be determined based on the plurality of positive pairing combinations, the plurality of negative pairing combinations, and a matching loss function of the initial image-text model. Specifically, an intermediate interactive feature corresponding to each pairing combination may be determined based on the plurality of positive pairing combinations and the plurality of negative pairing combinations, where the intermediate interactive feature may be extracted from the initial image-text model. Further, a matching probability corresponding to each pairing combination may be determined according to the intermediate interactive feature corresponding to each pairing combination. For example, the matching probability may be output via a binary classification head which may adopt a network architecture of a multi-layer perceptron (MLP) and a Sigmoid function as an activation function, so that an output value is mapped between (0, 1) by the Sigmoid function, thereby obtaining the matching probability.

Further, the matching loss value may be determined based on a preset classification label parameter and the matching probability corresponding to each pairing combination. Specifically, a single sample loss value of each pairing combination may be calculated by:

$${ℒ}_{ITM} = - ( y log \hat{p} + ( 1 - y ) log ( 1 - \hat{p} ) ) \qquad ( 6 )$$

where [symbol] _{ITM} is the single sample loss value, y is a preset classification label parameter and y∈{0, 1}, and \hat{p} is the matching probability. Further, the final matching loss value may be obtained by averaging or summing the obtained plurality of single sample loss values.

Furthermore, a semantic description loss value may be determined based on the item information training set and a semantic loss function of the initial image-text model. The semantic loss function may be expressed by:

$${ℒ}_{MLM} = - \frac{1}{\vert Ω \vert} {\sum }_{i ∈ Ω} log \hat{{y}_{ι}} ( {l}_{i} ) \qquad ( 7 )$$

where Ω={i|Mᵢ=1} is a set of all masked positions; Mᵢ is a Bernoulli variable, which is a value obtained by independently sampling each position i∈{1, . . . , L} of a text sequence of training item information with a fixed probability p (typically, p=0.15) (where L is a length of the text sequence). If Mᵢ=1, it indicates that an i^{th} basic unit (token) in the text sequence is selected to be masked (i.e., the i^{th} basic unit is replaced by a mask symbol); and if Mᵢ=0, it indicates that the i^{th} basic unit in the text sequence is not masked. lᵢ is a real word at an i^{th} position in the text sequence, and [symbol] (lᵢ) represents a predicted probability of generating a real word at the i^{th} position.

Further, a target loss value is determined based on the contrastive loss value, the matching loss value, and the semantic description loss value. In an embodiment of the present application, the contrastive loss value, the matching loss value, and the semantic description loss value may be weighted and combined to obtain the target loss value, which may be, for example, calculated by:

$${ℒ}_{total} = α \cdot {ℒ}_{contrastive} + β \cdot {ℒ}_{MLM} + γ \cdot {ℒ}_{ITM} \qquad ( 8 )$$

α, β and γ are all hyper-parameters, and may each have a relative importance adjusted according to the actual specific application requirements. For example: if the main objective is contrastive retrieval, then α may be larger; if the text quality is relatively good and high requirements are put on word level understanding, β may be increased; and if the whole image-text matching is desired to be finely divided and distinguished (not just ranked by similarity), γ can be increased accordingly.

Finally, whether the training of the initial image-text model is completed may be determined based on the target loss value. In an embodiment of the present application, a gradient of [symbol] ₜₒₜₐₗ may be calculated, and then all trainable parameters (including a visual encoder, a text encoder, a dimension reduction layer and the like) in the initial image-text model may be adjusted and updated according to a gradient direction. The optimizer for updating the parameters may be AdamW or Adam, and the learning rate may be set to e⁻⁵ to e⁻⁶, so as to prevent large-scale damage to the pre-training weights. When the target loss value is converged below the target value, it may be determined that the training of the initial image-text model is completed, thereby obtaining the multi-modal image-text model.

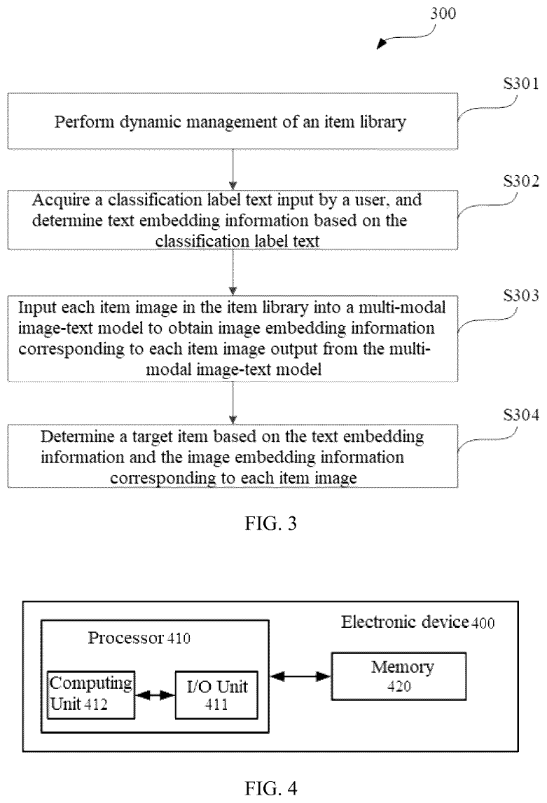

In some embodiments, dynamic management of the item library is desired to ensure timeliness and integrity of the item library. Further, the text embedding information may be subjected to a cosine similarity comparison with the image embedding information corresponding to each item image to determine the target item. The process of determining the target item will be described in detail below in conjunction with FIG. 3, which shows an exemplary flowchart of an item selection method according to yet other embodiments of the present application. Referring to FIG. 3, an item selection method according to an embodiment of the present application may include the following steps S301 to S304.

At step S301, dynamic management of an item library is performed. In an embodiment of the present application, the dynamic management of the item library may include, but is not limited to, updating new items into the item library, and performing dynamic management on each item in the item library according to an item state of each item in the item library.

Updating new items into the item library may specifically include: first, acquiring a new item list, where the new item list includes a new description text corresponding to each new item, and new picture information corresponding to each new item. Illustratively, the new item list may be acquired from a data warehouse tool HIVE of an item management platform. It will be appreciated that the new item list may be acquired in various manners, and in practical applications, the acquisition manner of the new item list is determined according to the practical application conditions, which is not limited in any manner in the present application.

Further, the new description text corresponding to each new item and the new picture information corresponding to each new item are input into the multi-modal image-text model, to obtain new text embedding information corresponding to each new item and new image embedding information corresponding to each new item output from the multi-modal image-text model, and then the new text embedding information corresponding to each new item and the new image embedding information corresponding to each new item are pushed to an item library index engine to update an item library index. Illustratively, for example, a distributed stream processing platform Kafka may be used to push the new text embedding information corresponding to each new item and the new image embedding information corresponding to each new item to a Milvus distributed index engine, and segmentation and index management on data are performed according to the country and the site, thereby updating of the item library index corresponding to the country and the site and ensuring access to the latest item information.

In addition, performing dynamic management on each item in the item library according to the item state of each item in the item library may specifically include: firstly, monitoring a data stream of item state change, for example, by the distributed stream processing platform Kafka, then determining a delisted item according to the data stream of item state change, and clearing delisting text embedding information and delisting image embedding information corresponding to the delisted item from the item library index, thereby ensuring validity of the target item.

At step S302, a classification label text input by a user is acquired, and text embedding information is determined based on the classification label text. In an embodiment of the present application, the content of step S302 is substantially the same as the content of steps S101 and S102, and thus is not repeated here.

At step S303, each item image in the item library is input into a multi-modal image-text model to obtain image embedding information corresponding to each item image output from the multi-modal image-text model. In an embodiment of the present application, the content of step S303 is substantially the same as the content of step S103, and thus is not repeated here.

At step S304, a target item is determined based on the text embedding information and the image embedding information corresponding to each item image. In an embodiment of the present application, a cosine similarity of the text embedding information and the image embedding information corresponding to each item image may be determined, where the cosine similarity may be used to measure a similarity between two vectors, i.e., the text embedding information and the image embedding information corresponding to each item image, so that the similarity between the text embedding information and the image embedding information corresponding to each item image can be judged. Then, at least one candidate matching item may be determined according to the cosine similarity. For example, items with the top ten cosine similarities may be recalled as candidate matching items. Further, the at least one candidate matching item is sorted according to a preset reference factor, and the target item is determined according to a sorted result. The preset reference factor may include, but is not limited to, item historical comments, item sales volumes, user preference data and the like. Finally, the most matched target item is determined.

Corresponding to the embodiments of the application function implementation method described above, the present application further provides a device for item selection and corresponding embodiments thereof.

FIG. 4 shows a block diagram of hardware configuration of a device 400 for item selection for implementing the item selection method according to an embodiment of the present application. As shown in FIG. 4, the device 400 for item selection may include a processor 410 and a memory 420. In the device 400 for item selection in FIG. 4, only constituent elements related to the present embodiment are shown. Therefore, it will be apparent to those of ordinary skill in the art that: the device 400 for item selection may further include common constituent elements other than those shown in FIG. 4, for example: a fixed-point arithmetic unit.

The device 400 for item selection may correspond to a computing device having various processing functions, such as functions for generation, training or learning of a neural network, for quantizing a floating point type neural network to a fixed point type neural network, or for retraining a neural network. For example, the device 400 for item selection may be implemented as various types of devices, such as a personal computer (PC), a server device, a mobile device, and so on.

The processor 410 controls all functions of the device 400 for item selection. For example, the processor 410 controls all functions of the device 400 for item selection by executing programs stored on the memory 420 in the device 400 for item selection. The processor 410 may be implemented by a central processing unit (CPU), a graphics processing unit (GPU), an application processor (AP), an intelligent processing unit (IPU), and the like provided in the device 400 for item selection. However, the present application is not limited thereto.

In some embodiments, the processor 410 may include an input/output (I/O) unit 411 and a computing unit 412. The I/O unit 411 may be configured to receive various types of data, for example, a classification label text input by a user. Illustratively, the computing unit 412 may be configured to determine text embedding information based on the classification label text received via the I/O unit 411; input each item image in an item library into a multi-modal image-text model to obtain image embedding information corresponding to each item image output from the multi-modal image-text model, where the multi-modal image-text model is trained based on an item picture sample set and an item information text corresponding to each item picture sample in the item picture sample set; and determine a target item based on the text embedding information and the image embedding information corresponding to each item image. The target item may be output from the I/O unit 411, for example. The output data may be provided to the memory 420 for reading by other devices (not shown), or may be provided directly to other devices for use.

The memory 420 is hardware for storing various data processed in the device 400 for item selection. For example, the memory 420 may store processed data and data to be processed in the device 400 for item selection. The memory 420 may store data sets processed or to be processed by the processor 410 involved in steps of the item selection method, such as a classification label text input by a user and the like. Further, the memory 420 may store applications to be driven by the device 400 for item selection, drivers, and the like. For example: the memory 420 may store various programs related to an item selection method to be executed by the processor 410. The memory 420 may be a DRAM, but the present application is not limited thereto. The memory 420 may include at least one of a volatile memory or a non-volatile memory. The non-volatile memory may include a read-only memory (ROM), a programmable ROM (PROM), an electrically programmable ROM (EPROM), an electrically erasable programmable ROM (EEPROM), a flash, phase-change RAM (PRAM), a magnetic RAM (MRAM), a resistive RAM (RRAM), a ferroelectric RAM (FRAM), or the like. The volatile memory may include a dynamic RAM (DRAM), a static RAM (SRAM), a synchronous DRAM (SDRAM), a PRAM, an MRAM, an RRAM, a ferroelectric RAM (FeRAM), or the like. In an embodiment, the memory 420 may include at least one of a hard disk drive (HDD), a solid state drive (SSD), a compact flash (CF), a secure digital (SD) card, a Micro-SD card, a Mini-SD card, an xD card, a cache, or a memory stick.

In summary, specific functions implemented by the memory 420 and the processor 410 of the device 400 for item selection provided in the implementations of the present disclosure may be explained in comparison with the foregoing implementations in the description of the present disclosure, and can achieve the technical effects of the foregoing implementations, and therefore, no further description is provided here.

In this implementation, the processor 410 may be implemented in any suitable manner. For example, the processor 410 may take the form of, for example, a microprocessor or processor and a computer-readable medium that stores a computer-readable program code (e.g., software or firmware) executable by the (micro) processor, a logic gate, a switch, an application specific integrated circuit (ASIC), a programmable logic controller, an embedded microcontroller, or the like.

It will also be appreciated that any module, unit, component, server, computer, terminal or device exemplified herein that executes instructions may include or otherwise have access to computer-readable media such as storage media, computer storage media, or data storage devices (removable and/or non-removable) such as, for example, magnetic disks, optical disks or tape. The computer storage medium may include volatile and non-volatile, removable and non-removable media implemented in any method or technology for storage of information, such as computer-readable instructions, data structures, program modules, or the like.

The foregoing may be better understood in light of the following clauses:

Clause A1. An item selection method, including: acquiring a classification label text input by a user; determining text embedding information based on the classification label text; inputting each item image in an item library into a multi-modal image-text model to obtain image embedding information corresponding to each item image output from the multi-modal image-text model, wherein the multi-modal image-text model is trained based on an item picture sample set and item information text corresponding to each item picture sample in the item picture sample set; and determining a target item based on the text embedding information and the image embedding information corresponding to each item image.

Clause A2. The item selection method of clause A1, wherein the multi-modal image-text model is trained based on the item picture sample set and the item information text corresponding to each item picture sample in the item picture sample set by: acquiring the item picture sample set and the item information text corresponding to each item picture sample in the item picture sample set; pre-processing each item picture sample and each item information text to obtain an item picture training set and an item information training set; loading a pre-training model and adding a dimension reduction layer into the pre-training model to obtain an initial image-text model; and inputting the item picture training set and the item information training set into the initial image-text model for training to obtain the multi-modal image-text model.

Clause A3. The item selection method of clause A2, wherein inputting the item picture training set and the item information training set into the initial image-text model for training includes: matching each piece of training item information in the item information training set with training item pictures in the item picture training set, to obtain a plurality of positive pairing combinations and a plurality of negative pairing combinations; determining a contrastive loss value based on the plurality of positive pairing combinations and a contrastive learning loss function of the initial image-text model; determining a matching loss value based on the plurality of positive pairing combinations, the plurality of negative pairing combinations, and a matching loss function of the initial image-text model; determining a semantic description loss value based on the item information training set and a semantic loss function of the initial image-text model; determining a target loss value based on the contrastive loss value, the matching loss value, and the semantic description loss value; and determining whether the training of the initial image-text model is completed based on the target loss value.

Clause A4. The item selection method of clause A3, wherein determining the contrastive loss value based on the plurality of positive pairing combinations and the contrastive learning loss function of the initial image-text model includes: inputting a training item picture in each positive pairing combination into a visual encoder of the initial image-text model to obtain an item picture feature output from the visual encoder; inputting training item information in each positive pairing combination into a text encoder of the initial image-text model to obtain an item information feature output from the text encoder; inputting the item picture feature and the item information feature into the dimension reduction layer to obtain a dimension reduction picture feature and a dimension reduction information feature; determining a similarity matrix based on the dimension reduction picture feature and the dimension reduction information feature; determining a first direction contrastive loss value and a second direction contrastive loss value based on the similarity matrix; and determining the contrastive loss value based on the first direction contrastive loss value and the second direction contrastive loss value.

Clause A5. The item selection method of clause A3, wherein determining the matching loss value based on the plurality of positive pairing combinations, the plurality of negative pairing combinations, and the matching loss function of the initial image-text model includes: determining an intermediate interactive feature corresponding to each pairing combination based on the plurality of positive pairing combinations and the plurality of negative pairing combinations; determining a matching probability corresponding to each pairing combination according to the intermediate interactive feature corresponding to each pairing combination; and determining the matching loss value based on a preset classification label parameter and the matching probability corresponding to each pairing combination.

Clause A6. The item selection method of clause A1, wherein determining the target item based on the text embedding information and the image embedding information corresponding to each item image includes: determining a cosine similarity of the text embedding information and the image embedding information corresponding to each item image; determining at least one candidate matching item according to the cosine similarity; and sorting the at least one candidate matching item according to a preset reference factor, and determining the target item according to a sorted result.

Clause A7. The item selection method of clause A1, wherein before acquiring the classification label text input by the user, the method further includes: acquiring a new item list, wherein the new item list includes a new description text corresponding to each new item, and new picture information corresponding to each new item; inputting the new description text corresponding to each new item and the new picture information corresponding to each new item into the multi-modal image-text model, to obtain new text embedding information corresponding to each new item and new image embedding information corresponding to each new item output from the multi-modal image-text model; and pushing the new text embedding information corresponding to each new item and the new image embedding information corresponding to each new item to an item library index engine to update an item library index.

Clause A8. The item selection method of clause A7, wherein before acquiring the classification label text input by the user, the method further includes: monitoring a data stream of item state change; determining a delisted item according to the data stream of item state change; and clearing delisting text embedding information and delisting image embedding information corresponding to the delisted item from the item library index.

Clause A9. A device for item selection, including: a memory; and at least one processor configured to: acquire a classification label text input by a user; determine text embedding information based on the classification label text; input each item image in an item library into a multi-modal image-text model to obtain image embedding information corresponding to each item image output from the multi-modal image-text model, wherein the multi-modal image-text model is trained based on an item picture sample set and item information text corresponding to each item picture sample in the item picture sample set; and determine a target item based on the text embedding information and the image embedding information corresponding to each item image.

Clause A10. A non-transitory machine-readable medium having a program code for item selection stored thereon which, when executed by at least one processor, directs the at least one processor to perform the operations of: acquiring a classification label text input by a user; determine text embedding information based on the classification label text; inputting each item image in an item library into a multi-modal image-text model to obtain image embedding information corresponding to each item image output from the multi-modal image-text model, wherein the multi-modal image-text model is trained based on an item picture sample set and item information text corresponding to each item picture sample in the item picture sample set; and determining a target item based on the text embedding information and the image embedding information corresponding to each item image.

What is claimed is:

1. An item selection method comprising:
acquiring a classification label text input by a user;
determining text embedding information based on the classification label text;
inputting each item image in an item library into a multi-modal image-text model to obtain image embedding information corresponding to each item image output from the multi-modal image-text model, wherein the multi-modal image-text model is trained based on an item picture sample set and item information text corresponding to each item picture sample in the item picture sample set; and
determining a target item based on the text embedding information and the image embedding information corresponding to each item image.

2. The item selection method of claim 1, wherein the multi-modal image-text model is trained based on the item picture sample set and the item information text corresponding to each item picture sample in the item picture sample set by:
acquiring the item picture sample set and the item information text corresponding to each item picture sample in the item picture sample set;
pre-processing each item picture sample and each item information text to obtain an item picture training set and an item information training set;
loading a pre-training model and adding a dimension reduction layer into the pre-training model to obtain an initial image-text model; and
inputting the item picture training set and the item information training set into the initial image-text model for training to obtain the multi-modal image-text model.

3. The item selection method of claim 2, wherein inputting the item picture training set and the item information training set into the initial image-text model for training includes:
matching each piece of training item information in the item information training set with training item pictures in the item picture training set, to obtain a plurality of positive pairing combinations and a plurality of negative pairing combinations;
determining a contrastive loss value based on the plurality of positive pairing combinations and a contrastive learning loss function of the initial image-text model;
determining a matching loss value based on the plurality of positive pairing combinations, the plurality of negative pairing combinations, and a matching loss function of the initial image-text model;
determining a semantic description loss value based on the item information training set and a semantic loss function of the initial image-text model;
determining a target loss value based on the contrastive loss value, the matching loss value, and the semantic description loss value; and
determining whether the training of the initial image-text model is completed based on the target loss value.

4. The item selection method of claim 3, wherein determining the contrastive loss value based on the plurality of positive pairing combinations and the contrastive learning loss function of the initial image-text model includes:
inputting a training item picture in each positive pairing combination into a visual encoder of the initial image-text model to obtain an item picture feature output from the visual encoder;
inputting training item information in each positive pairing combination into a text encoder of the initial image-text model to obtain an item information feature output from the text encoder;
inputting the item picture feature and the item information feature into the dimension reduction layer to obtain a dimension reduction picture feature and a dimension reduction information feature;
determining a similarity matrix based on the dimension reduction picture feature and the dimension reduction information feature;
determining a first direction contrastive loss value and a second direction contrastive loss value based on the similarity matrix; and
determining the contrastive loss value based on the first direction contrastive loss value and the second direction contrastive loss value.

5. The item selection method of claim 3, wherein determining the matching loss value based on the plurality of positive pairing combinations, the plurality of negative pairing combinations, and the matching loss function of the initial image-text model includes:
determining an intermediate interactive feature corresponding to each pairing combination based on the plurality of positive pairing combinations and the plurality of negative pairing combinations;
determining a matching probability corresponding to each pairing combination according to the intermediate interactive feature corresponding to each pairing combination; and
determining the matching loss value based on a preset classification label parameter and the matching probability corresponding to each pairing combination.

6. The item selection method of claim 1, wherein determining the target item based on the text embedding information and the image embedding information corresponding to each item image includes:
determining a cosine similarity of the text embedding information and the image embedding information corresponding to each item image;
determining at least one candidate matching item according to the cosine similarity; and
sorting the at least one candidate matching item according to a preset reference factor, and determining the target item according to a sorted result.

7. The item selection method of claim 1, wherein before acquiring the classification label text input by the user, the method further comprises:
acquiring a new item list, wherein the new item list includes a new description text corresponding to each new item, and new picture information corresponding to each new item;
inputting the new description text corresponding to each new item and the new picture information corresponding to each new item into the multi-modal image-text model, to obtain new text embedding information corresponding to each new item and new image embedding information corresponding to each new item output from the multi-modal image-text model; and
pushing the new text embedding information corresponding to each new item and the new image embedding information corresponding to each new item to an item library index engine to update an item library index.

8. The item selection method of claim 7, wherein before acquiring the classification label text input by the user, the method further comprises:
monitoring a data stream of item state change;
determining a delisted item according to the data stream of item state change; and
clearing delisting text embedding information and delisting image embedding information corresponding to the delisted item from the item library index.

9. A device for item selection, comprising:
a memory; and
at least one processor configured to:
acquire a classification label text input by a user;
determine text embedding information based on the classification label text;
input each item image in an item library into a multi-modal image-text model to obtain image embedding information corresponding to each item image output from the multi-modal image-text model, wherein the multi-modal image-text model is trained based on an item picture sample set and item information text corresponding to each item picture sample in the item picture sample set; and
determine a target item based on the text embedding information and the image embedding information corresponding to each item image.

10. A non-transitory machine-readable medium having a program code for item selection stored thereon which, when executed by at least one processor, directs the at least one processor to perform operations comprising:
acquiring a classification label text input by a user;
determining text embedding information based on the classification label text;
inputting each item image in an item library into a multi-modal image-text model to obtain image embedding information corresponding to each item image output from the multi-modal image-text model, wherein the multi-modal image-text model is trained based on an item picture sample set and item information text corresponding to each item picture sample in the item picture sample set; and
determining a target item based on the text embedding information and the image embedding information corresponding to each item image.
